(19) United States
(12) Patent Application Publication
(10) Pub. No.: US 2008/0067200 A1
(43) Pub. Date: Mar. 20, 2008

(54) Spare wheel cover

(76) Inventor: Arnon Bernshtein, Tel Aviv (IL)

Correspondence Address: Brux Software Solutions Ltd., 8 Gordon Street, Givatayim, 53235, omitted

(21) Appl. No.: 11/889,266

(22) Filed: Aug. 13, 2007

Related U.S. Application Data
(60) Provisional application No. 60/845,256, filed on Sep. 18, 2006.

(51) Int. Cl. B62D 43/02; B60R 9/06

(52) U.S. Cl. 224/42.13

(57) ABSTRACT

A spare wheel cover comprising: a vaulted external panel having an external side and an internal side, said external panel comprising: a first opening at the top thereof; and means for attaching holding straps; and a circular band for covering the circumference of the wheel, wherein the internal side of said external panel is adapted to be mounted against the wheel and wherein said means for attaching are adapted to hold straps, said straps wound around said wheel and said cover and wherein said vaulted external panel and said wheel define a storage volume.

### CROSS-REFERENCE TO RELATED PATENT APPLICATIONS

This patent application claims priority from and is related to U.S. Provisional Patent Application Ser. No. 60/845,256, filed 18 Sep. 2006, this U.S. Provisional Patent Application incorporated by reference in its entirety herein.

### FIELD OF THE INVENTION

The present invention pertains to wheel covers and more specifically to spare wheel covers having additional functionalities.

### BACKGROUND OF THE INVENTION

The use of a vehicle spare wheel cover is well known in the prior art. The main deficiency of existing spare wheel covers is their lack of functionality other than protecting the spare tire.

Several patents and published applications have addressed this problem in different manners, as detailed below:
US Published Application No. 20060055161 to Bartorelli et al;
U.S. Pat. No. 5,228,608 to Stout;
U.S. Pat. No. 5,203,479 to Lucas;
U.S. Pat. No. 5,118,017 to Buck;
U.S. Pat. No. 4,498,614 to Guarr;
International Published Application WO9525033 to Haslbeck; and
International Published Application WO2007027185 to Fischer et al None of the above referenced publications provide for advantageously storing a water bladder in the spare wheel cover.

### SUMMARY OF THE INVENTION

According to a first aspect of the present invention, there is provided a spare wheel cover comprising: a vaulted external panel having an external side and an internal side, said external panel comprising: a first opening at the top thereof; and means for attaching holding straps; and a circular band for covering the circumference of the wheel, wherein the internal side of said external panel is adapted to be mounted against the wheel and wherein said means for attaching are adapted to hold straps, said straps wound around said wheel and said cover and wherein said vaulted external panel and said wheel define a storage volume.

According to a first embodiment, the spare wheel cover additionally comprises an internal partition adapted to be mounted between said external panel and said wheel.

According to a second embodiment, the internal partition comprises means for attaching holing straps, respective to said means in said external panel.

According to a third embodiment, the external panel additionally comprises, at the lower part thereof, a second opening.

According to a fourth embodiment, the volume defined between said external panel and said wheel is adapted to store a water bladder, whereby said second opening is adapted to accommodate the plug of said water bladder.

According to a fifth embodiment, the second opening comprises two connected holes, said two connected holes having different diameters.

According to a sixth embodiment, the means for attaching holding straps comprise holes.

According to a seventh embodiment, the means for attaching holding straps comprise protrusions.

According to an eighth embodiment, the circular band is a metal band.

According to a ninth embodiment, the circular band is a cloth band.

According to a tenth embodiment, the circular cloth band Is made of vinyl.

According to an eleventh embodiment, the circular cloth band comprises: a rigid band connected to one said thereof; and an elastic rope threaded through a hem on the other side thereof, wherein said rigid band is adapted to be mounted on said wheel circumference and wherein said elastic rope is adapted to draw the cloth band tightly to the wheel circumference.

### BRIEF DESCRIPTION OF THE DRAWINGS

FIG. 1 is an overall view of the spare wheel cover according to one embodiment of the present invention;

FIG. 2 is an exploded view of the cover of FIG. 1;

FIGS. 3a through 3c show an exemplary opening for inserting a water bladder plug according to the present invention;

FIG. 4 is an overall view of the spare wheel cover according to a second embodiment of the present invention;

FIG. 5 is an exploded view of the cover of FIG. 4;

FIG. 6 is an exploded view of the bicycle rack according to the second embodiment;

FIG. 7 shows a bicycle hanging on the spare wheel cover according to the second embodiment;

FIGS. 8a through 8c are schematic drawings of a fabric band according to the present invention;

FIGS. 9 and 10 depict an exemplary plug according to the present invention; and

FIG. 11 shows the spare wheel cover of the present invention strapped to the wheel.

### DETAILED DESCRIPTION OF PREFERRED EMBODIMENTS

The present invention provides a spare wheel cover for spare wheels attached externally, mostly on the back part of a vehicle.

The spare wheel cover of the present invention provides additional functionality, as will be explained below in conjunction with the drawings.

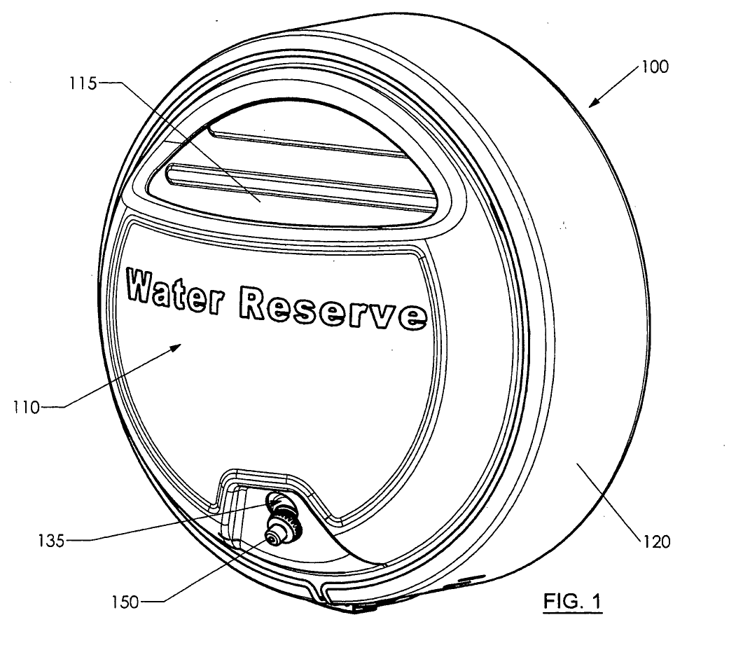

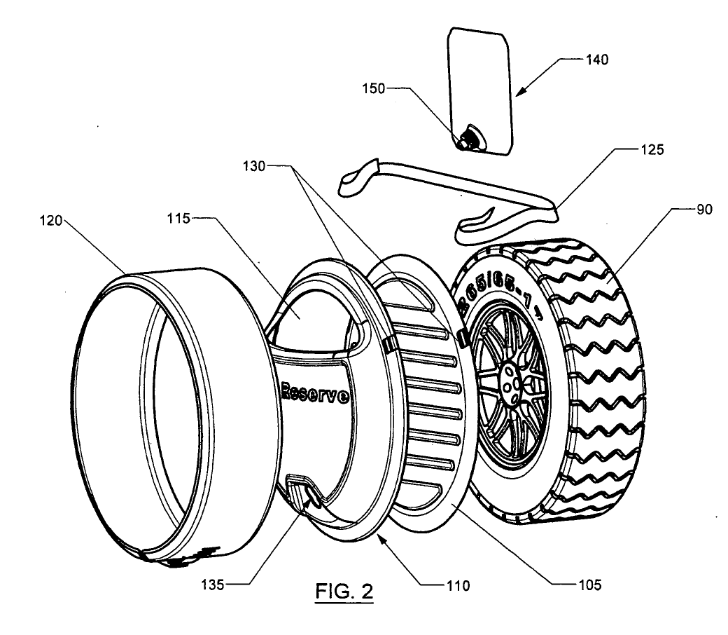

FIG. 1 is an overall view of the spare wheel cover 100, which has additional storage functionality. FIG. 2 is an exploded view of the cover of FIG. 1.

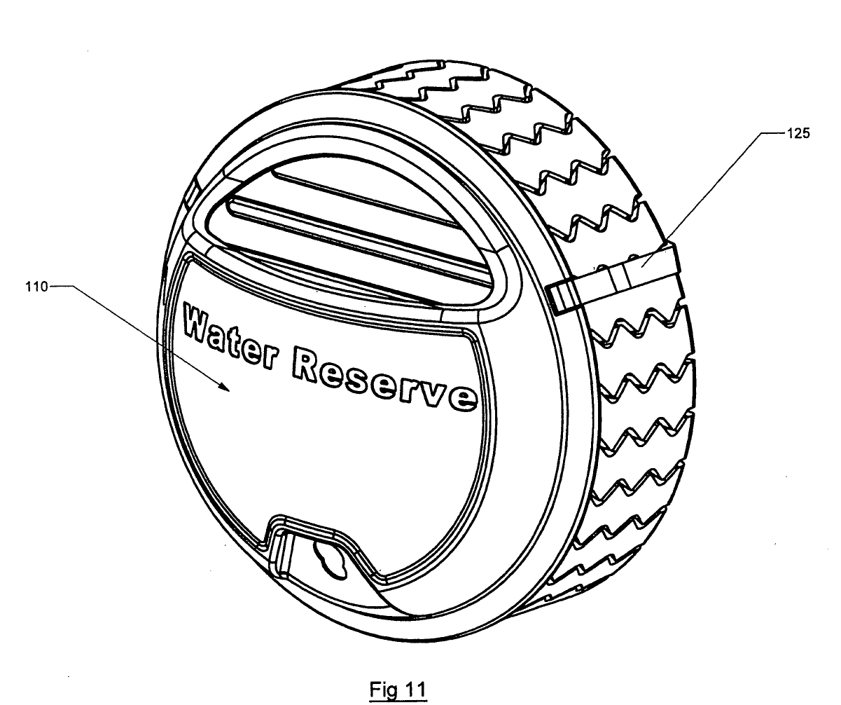

Spare wheel cover 100 comprises, in assembly order, an internal partition 105, optionally used for aesthetic reasons, in order to hide the wheel, a vaulted external panel 110, having an opening 115 at the top thereof and a metal band 120 for covering the circumference of the spare wheel and providing additional holding means for cover 100. A securing strap 125, made of non-elastic material such as Vinyl, is threaded through matching holes 130 in both the internal partition (if existing) and the external cover, and then drawn around the spare wheel, to secure the cover to the wheel. In an alternative embodiment, the securing strap may be wound around matching protrusions in both the internal partition (if existing) and the external cover and then drawn around the spare wheel, as shown in FIG. 11.

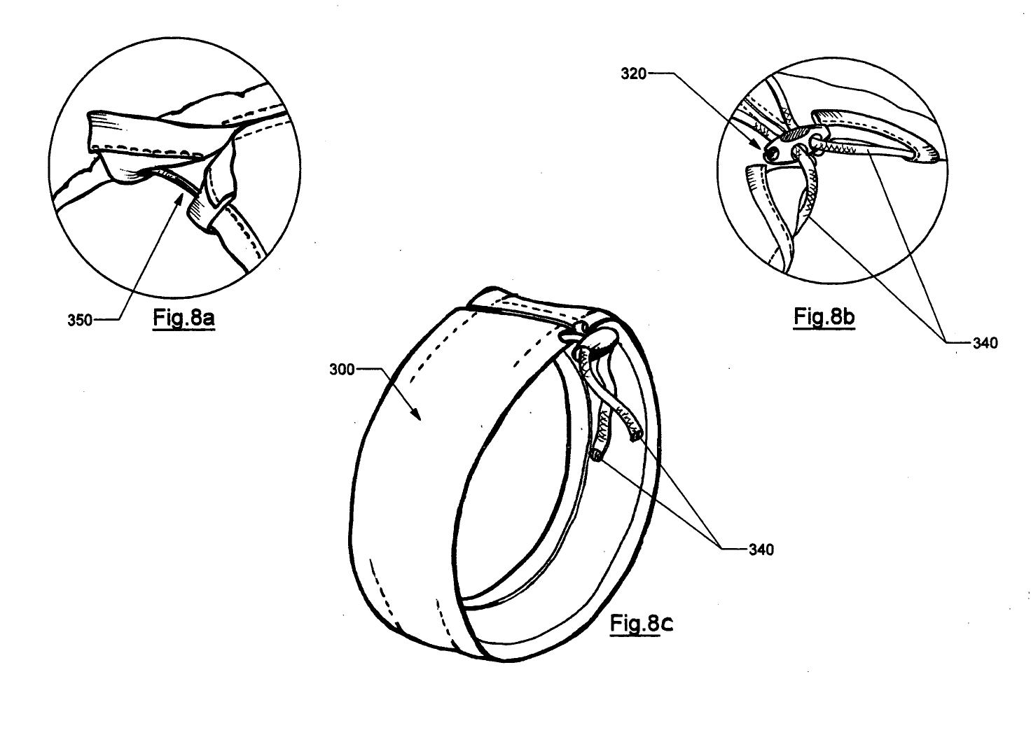

In a preferred embodiment of the invention, metal band 120 may be replaced by a fabric band, rendering the spare wheel cover less expensive, as will be explained in detail in conjunction with FIG. 8.

The vaulted shape of external panel 110 defines a storage volume between the wheel or the internal partition 105 and the external part of cover 100, which may be used to store a variety of items. In a preferred embodiment of the present invention the storage volume is used for storing a water bladder. According to this embodiment external panel 110 comprises an additional opening 135 at the bottom thereof, to enable pouring water without having to pull out the water bladder. A water bladder 140, sealed by plug 150 on its lower part as known in the art, is inserted vertically through opening 115 into the storage volume, so that plug 150 emerges through opening 135 of the cover, ready for use.

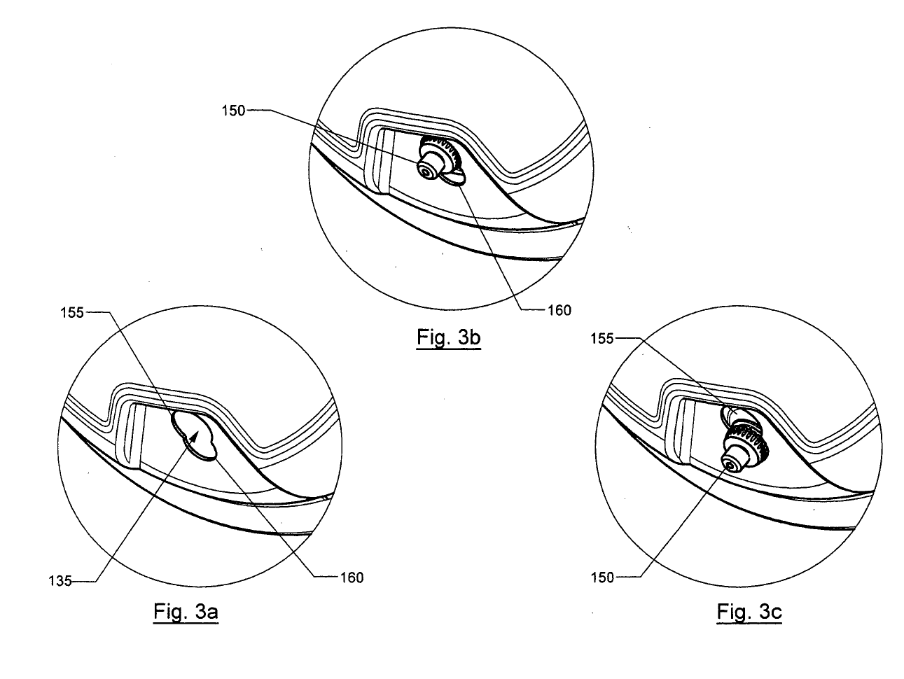

FIGS. 3a through 3c depict an exemplar process of securing the water bladder 140 to the spare wheel cover 100. FIG. 3a shows the details of an exemplary opening 135, comprising two connected holes 155 and 160, where the bottom hole 160 has a smaller diameter than the upper hole 155. In FIG. 3b, the plug 150 is inserted from within the storage volume, through upper hole 155. In FIG. 3c, the plug 150 is pushed towards the lower hole 160, so that its narrower part fits tightly into the hole. The water bladder is thus secured inside the spare wheel cover and ready for use.

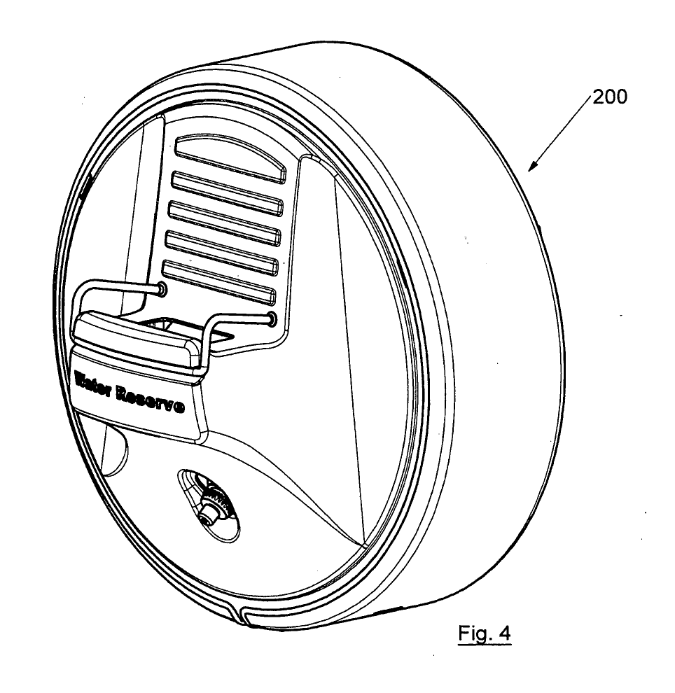

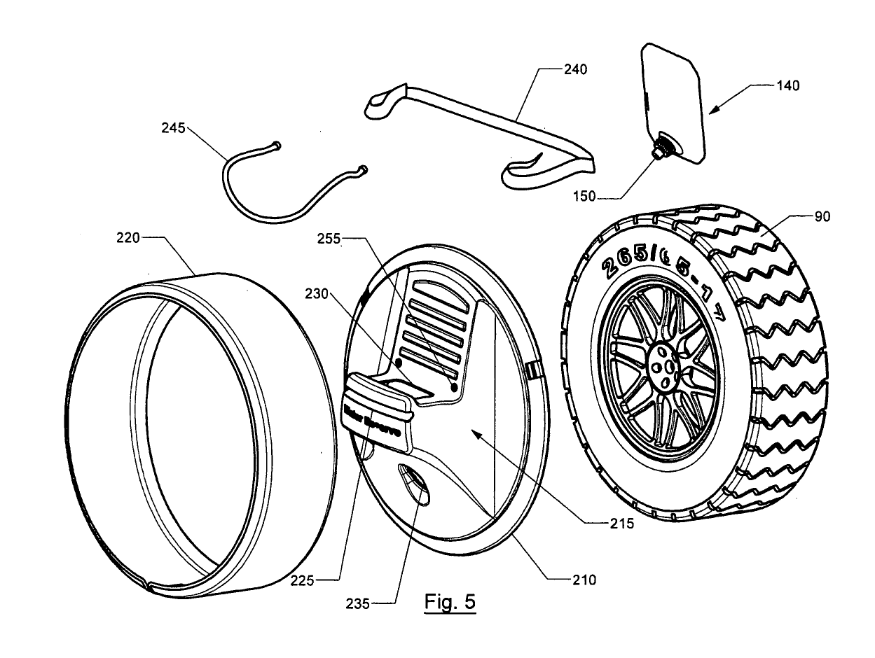

FIG. 4 depicts a general view of a second preferred embodiment of the present invention, wherein the spare wheel cover of the present invention functions both for storage and for carrying bicycles. FIG. 5 is an exploded view of the cover of FIG. 4.

Spare wheel cover 200 comprises, in assembly order, an external cover 210, comprising a bicycle rack 215 and a band 220 for covering the spare wheel. As in the first embodiment, band 220 may be made of fabric or metal.

The bicycle rack 215 comprises a hollow protruding portion 225, which serves as a hanger for the bicycle. An opening 230 at the top of portion 225 serves for inserting a water bladder, or any other items to be stored. In the embodiment of a water bladder, the external cover will also have a bottom opening 235, similar to opening 135 which has been described in conjunction with the first embodiment. A securing strap 240, similar to strap 125 of the first embodiment, serves to attach the cover to the wheel. Additionally, an elastic rope 245 may be used to secure the bicycle hanging on the rack.

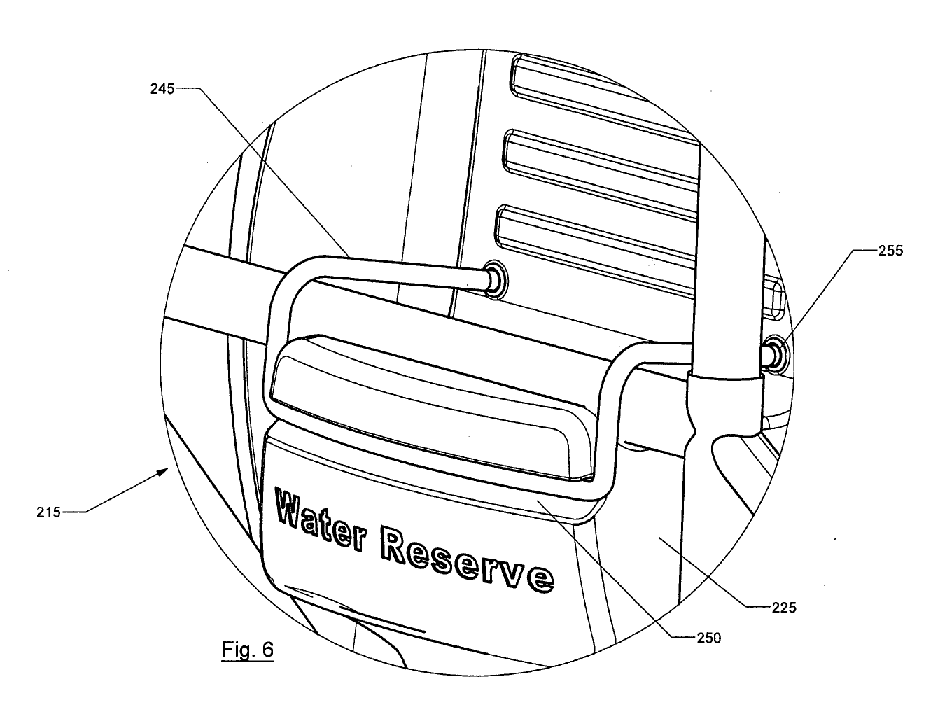

FIG. 6 is an exploded view of the bicycle rack 215, showing a niche 250 designed to accommodate the elastic rope 245, which is connected on its two ends to the cover body, e.g. by threading it through holes 255. After the bicycle has been hung on the rack, the elastic rope 245 is drawn into the niche 250.

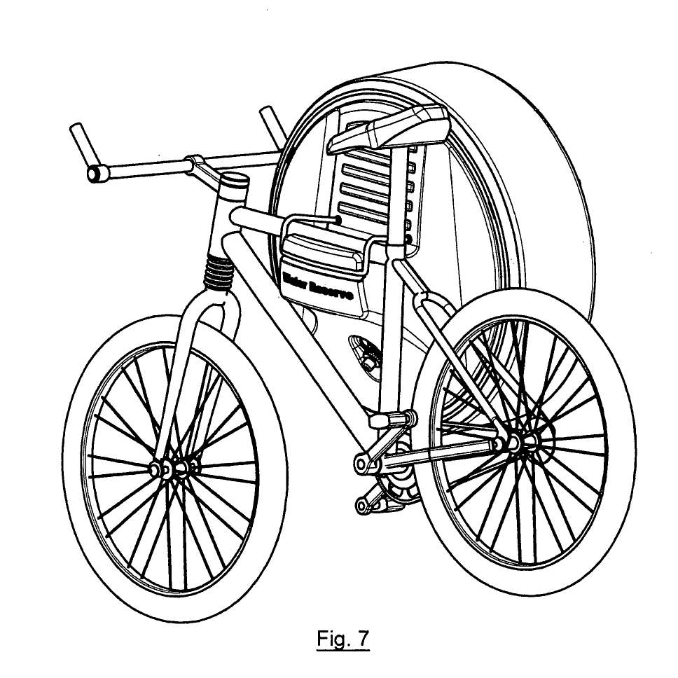

FIG. 7 shows a bicycle hanging on the spare wheel cover according to the present invention.

FIGS. 8a through 8c are schematic drawings of a fabric band covering the spare wheel, instead of the metal band, as described in the previous embodiments. In a preferred embodiment, the fabric band 300, made of elastic fabric such as vinyl, comprises a rigid metal or plastic string 350 threaded into its hem on one side, for maintaining the circular structure of fabric band 300 and preventing it from slipping off the wheel and cover, and a tightening elastic rope 340, such as a bangi rope, threaded through the opposite hem. When the tightening strap 340 is tightened, e.g. using a cord lock 320, the fabric is stretched evenly.

A fabric band has several advantages over a metal band; it is cheaper and it may adapt to various wheel sizes.

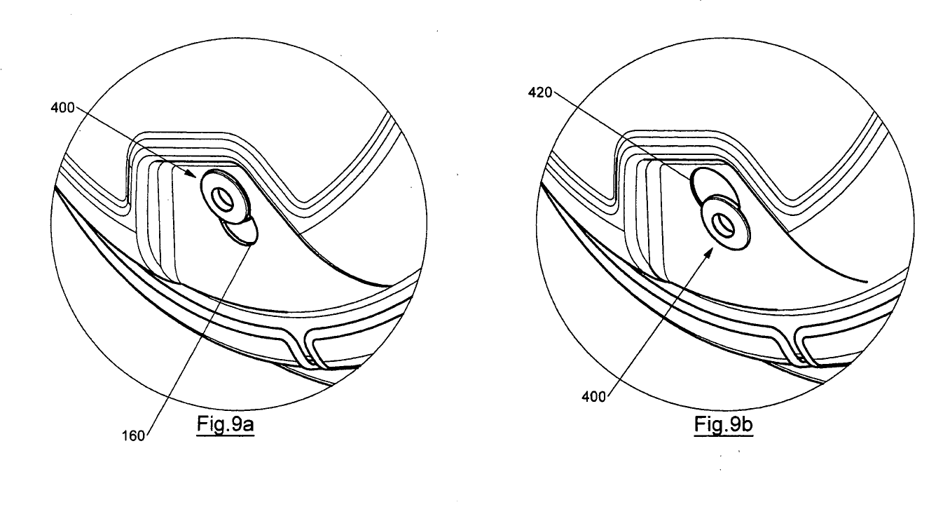

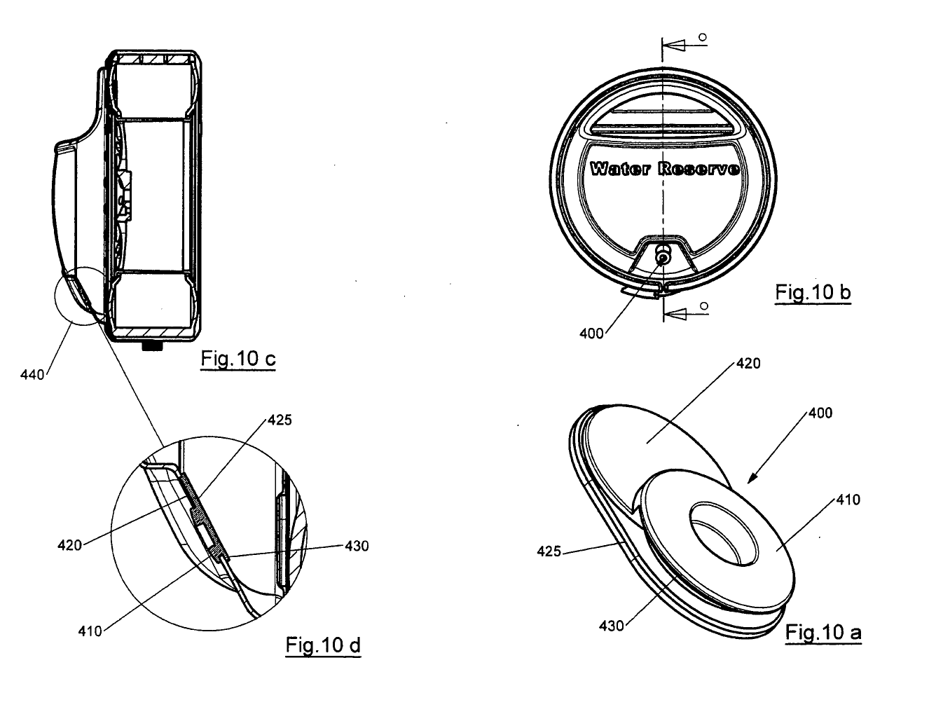

FIGS. 9 and 10 depict an exemplary plug designed to close the bottom hole 135 of the spare wheel cover according to the present invention, when the storage volume does not contain a water bladder and may be used as general purpose storage. Plug 400 is preferably made of Plastic.

In FIG. 9a, the plug 400 is shown in its open position and in FIG. 9b the plug 400 is shown in its closed position, as will be explained below in conjunction with FIG. 10.

FIG. 10a is a schematic drawing of plug 400 according to the present invention, comprising two connected spheres 410 and 420, mounted on a common bottom 425. Sphere 410 is elevated relative to sphere 420 and comprises a narrower “neck” 430.

In operation, sphere 410 is inserted into upper hole 155 from within the storage volume, plug 400 is then pushed downward so that neck 430 fits into lower hole 160 and at the same time sphere 420 covers the opening of hole 155.

FIG. 10b is a front view of the spare wheel cover according to this embodiment.

FIG. 10c is a section view o-o of spare wheel cover of FIG. 10b.

Fig. 10d is a detail view of area 440 of FIG. 1c, depicting plug 400 in position for sealing the storage volume.

1. A spare wheel cover comprising:
a vaulted external panel having an external side and an internal side, said external panel comprising:
a first opening at the top thereof; and
means for attaching holding straps; and
a circular band for covering the circumference of the wheel,
wherein the internal side of said external panel is adapted to be mounted against the wheel and wherein said means for attaching are adapted to hold straps, said straps for wounding around the wheel and wherein said vaulted external panel and said wheel define a storage volume.

2. The spare wheel cover of claim 1, additionally comprising an internal partition adapted to be mounted between said external panel and said wheel.

3. The spare wheel cover of claim 2, wherein said internal partition comprises means for attaching holing straps, respective to said means in said external panel.

4. The spare wheel cover of claim 1, wherein said external panel additionally comprises, at the lower part thereof, a second opening.

5. The spare wheel cover of claim 4, wherein said volume defined between said external panel and said wheel is adapted to store a water bladder, whereby said second opening is adapted to accommodate the plug of said water bladder.

6. The spare wheel cover of claim 5, wherein said second opening comprises two connected holes, said two connected holes having different diameters.

7. The spare wheel cover of claim 1, wherein said means for attaching holding straps comprise holes.

8. The spare wheel cover of claim 1, wherein said means for attaching holding straps comprise protrusions.

9. The spare wheel cover of claim 1, wherein said circular band is a metal band.

10. The spare wheel cover of claim 1, wherein said circular band is a cloth band.

11. The spare wheel cover of claim 10, wherein said circular cloth band is made of vinyl.

12. The spare wheel cover of claim 10, wherein said circular cloth band comprises:
a rigid band threaded through a first hem on one side thereof; and
an elastic rope threaded through a second hem on the other side thereof, said rigid band adapted to be mounted on said wheel circumference and said elastic rope adapted to draw the cloth band tightly to the wheel circumference.
